(19) United States
(12) Patent Application Publication
(10) Pub. No.: US 2016/0238170 A1
(43) Pub. Date: Aug. 18, 2016

(54) DEVICE FOR DEFLATING AN ITEM

(71) Applicant: ROBERT PYTEL, Oak Forest, IL (US)

(72) Inventor: ROBERT PYTEL, Oak Forest, IL (US)

(21) Appl. No.: 14/622,793

(22) Filed: Feb. 13, 2015

(51) Int. Cl. F16L 37/02; F16L 37/38

(52) U.S. Cl. CPC F16L 37/02; F16L 37/38

(57) ABSTRACT

A device is provided for deflating an inflated item. The device has a first penetrating lip end for displacing a counter-valve within an air valve on the inflated item. A second end of the device has a planar annular peripheral ring for airtight contact with the vacuum source. A stem extending between the two ends facilitates deflation of the device by allowing air flow through a central aperture. The device may be used in conjunction with a vacuum source. The force of vacuum suction holds the vacuum source into contact with the device without the need for mechanical connection members.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to devices for deflating an item, specifically to a device that is used with a vacuum source for rapidly deflating the item.

2. Description of the Related Art

Inflatable items such as pool toys typically have a valve for inflating and deflating the item. When deflation is desired, typically the valve must be squeezed or pinched in order to allow air to escape, because most valves have a counter-valve for blocking the release of air even when the valve is in an open position. Pinching and squeezing the valve wears the material surrounding the valve, and can lead to tearing. The process also consumes time, so a person may hug or squeeze the item in order to hasten the removal of air, but this practice causes the item to rupture. In most cases, the air is displaced unevenly throughout the item one squeezed, and so air remains in the item which hinders folding and storage of the item. The prior art devices desired for inflating, and deflating an item utilize bulky and complex attachment parts for connecting a vacuum to the device.

### BRIEF SUMMARY OF THE INVENTION

A device for deflating an item may be utilized in conjunction with a vacuum source for rapid deflation of the item. The device receives the vacuum source for making an airtight fit, and the vacuum suction force holds the vacuum source onto the device without the need for a connecting member. The device removes substantially all the air to allow easier fold-up and storage of the item, eliminating the need for pinching the air valve on the item and squeezing the item to force air therefrom.

### BRIEF DESCRIPTION OF THE SEVERAL VIEWS OF THE DRAWINGS

FIG. 1 is a view in perspective of the device, with the central aperture at the tip end displayed.

FIG. 2 is a cross sectional view of the device, with arrows displaying the air flow through the central aperture.

FIG. 3 is a cross sectional view of the device during use in conjunction with a vacuum source, with the tip portion inserted through a valve of an inflated device with arrows displaying the air flow through the central aperture and into the vacuum source hose.

### DETAILED DESCRIPTION OF THE INVENTION

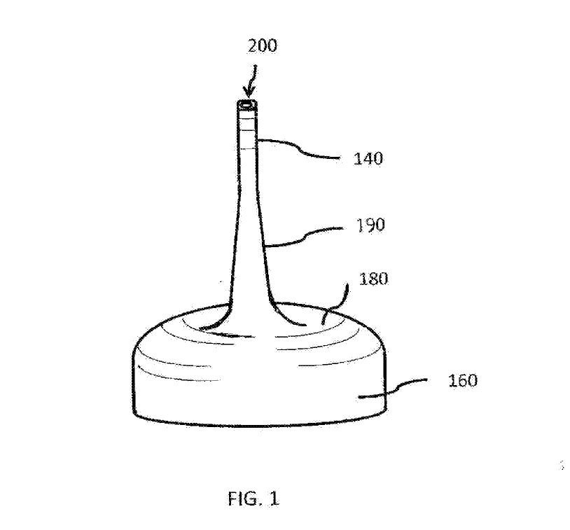

Referring to FIG. 1 a device 100 according to an aspect of the invention is illustrated. The device 100 has a foremost tip 140 portion. A second receiving portion 160 distal to the tip 140 has a peripheral annular wall 180. A stem portion 190 extends longitudinally between the tip 140 and receiving portion 160. The stem 190 and tip 140 are formed with an inner cylindrical void space called a central aperture 200, which extends through the device 100.

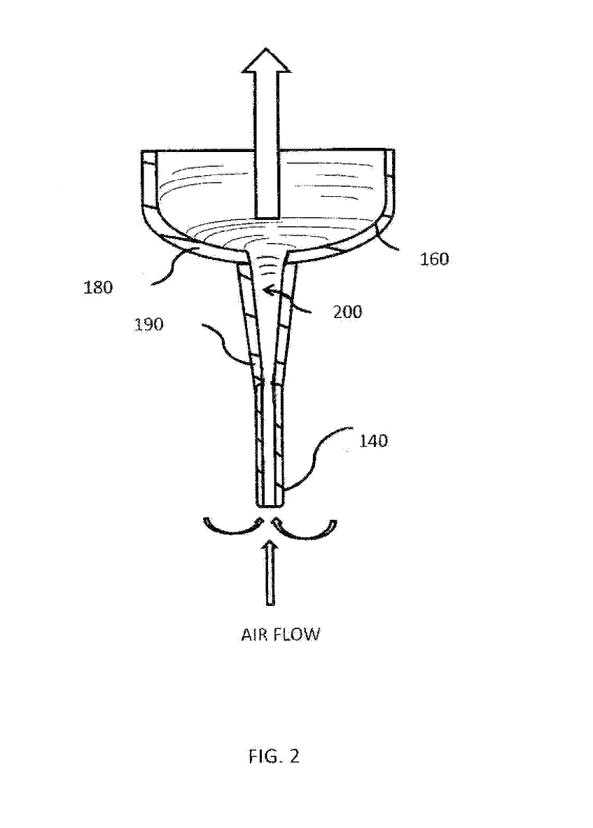

FIG. 2 is a cross-sectional view in perspective exhibiting air flows through the central aperture 200 extending within the stem portion 190. The annular wall 180 is formed contiguous with the stem 190 and is positioned substantially planar and perpendicular to the central aperture 200. Air flow is represented by the arrows flowing into the central aperture 200 at the tip portion 140.

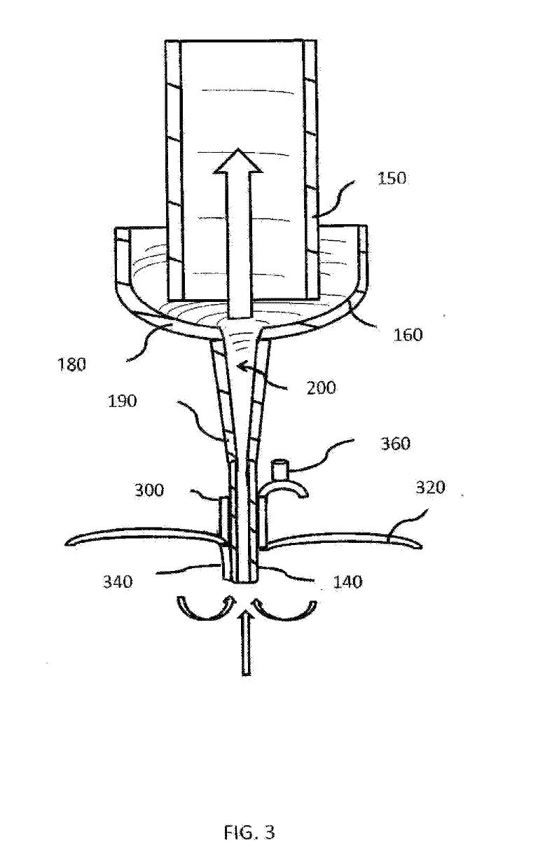

In FIG. 3, also in cross section, the device 100 is shown inserted into a standard air valve 300, which has a counter-valve 340 and a plug 360. A portion of a membrane 320 of an inflated item is shown. Contact between the air valve 300 and the tip 140 results in a friction fit that holds the device 100 in place. When a user desires to remove air from an inflated item, the plug 360 is removed from the valve 300. The tip 140 is inserted into the valve 300. The counter-valve 340 is displaced from a first resting position in which the counter-valve 340 is substantially blocking air flow through the central aperture 200, to a second open position in which the counter-valve 340 is substantially parallel to the central aperture 200. In FIG. 3, the counter-valve 340 is shown in the second position, displaced from blocking air now through the valve.

Also exhibited in FIG. 3, the device 100 is preferably used in conjunction with a common household vacuum cleaner, or a shop-vacuum cleaner, both of which are typically equipped with a hose. The hose 150 becomes suction-coupled with the device 100 rapidly remove air from the inflated item. While in the ‘on’ position, the user places the hose 150 against the annular wall 180 inside the receiving end 160. The suction action of the vacuum results in an airtight contact between the hose 150 and the device 100.

In other embodiments, a device may be formed tapered at a tip region. The tapered protrusions at the tip make contact with a valve, resulting in a mechanical and friction fit to hold the device in the valve as the device is deflated.

In another embodiment, a device has a threaded tip for inserting into a valve. A helical threaded tip also works to hold the device on the valve in a friction and mechanical manner. In all uses of the device 100 there is no latch or clip required for obtaining a connection that is secure enough to achieve the desired results. The device 100 provides for rapid deflation of most items and removes substantially all the air to allow easier fold-up and storage of the item.

The device 100 may be fabricated from a rigid, lightweight, plastic material, for example, polyethylene, polycarbonate, or other suitable plastic material. Suitable vacuum sources for use with the present invention includes most household vacuums and shop vacuums.

While certain preferred embodiments of the present invention have been disclosed in detail, it is to be understood that various modifications may be adopted without deputing from the spirit of the invention or scope of the following claims.

1. A device for deflating an inflated item, said device comprising:
a longitudinal stem having a first penetrating end with a tip portion and a second receiving end formed distal to said first penetrating end;
a central aperture extending longitudinally within said stem between said first end and said second end;
a planar annular plate formed contiguous with said second end, and substantially perpendicular to said stem and aperture;
wherein upon insertion of said first penetrating end into an air valve on said inflated item, said tip portion displaces a counter valve within said air valve, and air is released from said item through said aperture.

2. A device for deflating an inflated item in conjunction with a vacuum source, said device comprising:
longitudinal stem having a first penetrating end with a tip portion and a second receiving end formed distal to said first penetrating end;
a central aperture extending longitudinally within said stem between said first end and said second end;
a planar annular plate formed contiguous with said second end, and substantially perpendicular to said stem and aperture;
wherein upon placement of said vacuum source against said plate and insertion of said first penetrating end into an air valve on said inflated item, said tip portion displaces a counter valve within said air valve, and air is rapidly drawn from said item through said aperture.

3. A method for deflating an inflated item in conjunction with a vacuum source, comprising the steps of:
providing a longitudinal stem having a first penetrating end with a tip portion and a second receiving end formed distal to said first penetrating end;
a central aperture extending longitudinally within said stem between said first end and said second end;
a planar annular plate formed contiguous with said second end, and substantially perpendicular to said stem and aperture;
placing said vacuum source against said plate;
inserting said first penetrating end into an air valve on said inflated item to a distance that results in the tip portion contacting and displacing a counter-valve within said air valve and results in a frictional connection between said stem and said valve; and,
drawing air from said item through said aperture to said vacuum source.

7. A method for deflating an inflated item, comprising the steps of:
providing a longitudinal stem having a first penetrating end with a tip portion and a second receiving end formed distal to said first penetrating end;
a central aperture extending longitudinally within said stem between said first end and said second end;
a planar annular plate formed contiguous with said second end, and substantially perpendicular to said stem and aperture;
inserting said first penetrating end into an air valve on said inflated item to a distance that results in the tip portion contacting and displacing as counter-valve within said air valve and results in a frictional connection between said stem and said valve, whereby air flows out of said item through said aperture.
